(19) United States
(12) Patent Application Publication
(10) Pub. No.: US 2007/0192195 A1
(43) Pub. Date: Aug. 16, 2007

(54) System and method of economic incentives to foster behavioral changes that improve health

(76) Inventors: Alejandro G. Asmar, Rio Piedras, PR (US); Arturo Diaz, Rio Piedras, PR (US)

Correspondence Address: MEREK, BLACKMON & VOORHEES, LLC, 673 S. WASHINGTON ST., ALEXANDRIA, WV, 22314, US

(21) Appl. No.: 11/724,321

(22) Filed: Mar. 15, 2007

Related U.S. Application Data
(63) Continuation-in-part of application No. 11/338,634, filed on Jan. 25, 2006.

(51) Int. Cl. G06Q 30/00; G06Q 10/00

(52) U.S. Cl. 705/14; 705/2

(57) ABSTRACT

A web based electronic system with the capacity to record vital behavioral information while providing a platform for participating insurance companies to offer incentives for patients to engage in specific preventive care and/or health promotion practices. The system includes either an electronic funds transfer card that can be used as a debit or charge card to purchase goods and services, or a magnetic strip card as an ID to record the transaction. At checkout, the system operates invisibly to the consumer and the cashier. Approval of the transaction operates similarly to a conventional debit card or credit card. All incentives are managed by the data clearinghouse which receives patient data and provider data. The clearinghouse communicates with the insurance company and forwards a statement which displays the historical behavior.

### RELATED APPLICATIONS

This application is a continuation-in-part of co-pending patent application Ser. No. 11/338,634 filed Jan. 25, 2006 and incorporates that application herein by reference in its entirety.

### FIELD OF THE INVENTION

This invention relates to a web based electronic capture system that provides for economic interventions to create incentives for consumer behavior changes to engage in specific preventive care or health promotion practices.

### BACKGROUND OF THE INVENTION

Providing effective health care is an important concern for governments, insurance companies, hospitals, doctors and patients. Several attempts have been made to contain the rising costs of health care while providing improved quality of care overall. The Institute of Medicine's (IOM) recent Quality Chasm report suggests that the U.S. health care system requires major re-engineering, including major realignment of incentives, if health care is to provide collaborative quality care and care management and effectively prevent and manage chronic disease. Growing recognition of this need for realignment has led to “pay for quality” initiatives for providers and a parallel search for effective economic interventions for consumer health behavior change. Similar “pay for prevention” initiatives are used to address the gap between the high cost of preventable disease and deaths and the actual practices of health providers and consumers. These initiatives use explicit, or extrinsic, incentives such as bonuses and cash or other in-kind financial incentives for providers and consumers to engage in specific preventive care or health promotion practices. Nearly half of the nation's premature deaths from the ten leading causes of mortality are attributable to controllable behavioral factors such as unhealthy diet, lack of exercise, tobacco use, alcohol and drug abuse, and risky sexual practices. Behavioral health risks are also associated with higher ambulatory care and hospitalization costs—accounting for as much as 70 percent of all medical care spending. Behavior changes interventions delivered in health care settings yield positive outcomes.

The nation needs new strategies to prevent cancer and, when cancer occurs, to catch it at its earliest stages. The possible reductions in cancer incidence are particularly striking for certain cancers: accelerated changes in risk behavior could halve the number of smoking-related cancers

To save the most lives from cancer, health care providers, health plans, insurers, employers, policy makers, and researchers should be concentrating their resources on helping people to achieve those behavioral changes, and get early screens for cancer. The health benefits of such behavioral changes extend beyond cancer to cardiovascular disease and diabetes as well.

In the current environment of a growing chronic illness burden and an improving identification of risk factors for major diseases such as heart disease, the boundaries between primary, secondary, and tertiary prevention begin to blur. For example, high cholesterol and hypertension, though risk factors, are identified as treatable conditions. However, the purpose of treating high cholesterol is prevention of full-blown heart disease.

Preventive care and health promotion in this context is defined as those situations in which consumers may consider themselves healthy or physically at risk but have not yet been labeled with a diagnosis.

Disease prevention and health promotion cover a wide spectrum of behaviors for both consumers and providers, from simple, one-time vaccinations to complex behavioral changes such as weight control.

Economic incentives are explicit incentives targeted at specific individuals, either providers or consumers. Incentives offered to providers could include direct payments or bonuses to the provider or his/her group. It was expected that economic incentives would vary considerably by the nature of the incentive, the components involved, size, frequency, duration, and the conditions that triggered payment of the incentive. More diffuse incentives offered as part of managed care, e.g., waiving co-payments, were excluded for both consumers and providers because of the difficulty in pinpointing their specific effect. Consumer incentives are fairly straightforward and include cash, gifts, lotteries, and other free or reduced price goods and services for the benefit of the specific consumer.

Interventions are activities used by program planners to bring about the outcomes identified in the program objectives. These activities are also sometimes referred to as treatments. Although many times an intervention is made up of a single activity, it is more common for planners to use a variety of activities to make up an intervention for a program. Intervention activities are often categorized into the following groups:

Communication activities

Educational activities or methods

Behavior modification activities

Environmental change activities

Regulatory activities

Community advocacy activities

Organizational culture activities

Economic and other incentives

Health status evaluation activities

Social intervention activities

Technology-delivered activities

Incentives can increase the perceived value of an activity, motivate people to get involved, and remind program participants of their commitment to and goals for behavior change. Program planners who choose to use incentives need to consider the following factors.

1) Make sure everyone can receive one, whatever the incentive may be.

2) Make the incentives useful and meaningful.

3) Ensure that the ground rules are fair, understandable, and followed by everyone.

4) Make a big deal of awarding the incentive.

5) Use incentives that are consistent with health promotion philosophies. For example, avoid incentives of alcoholic beverages, high fat or high sugar foods, or other mixed-message prizes.

Disincentives—can be used to discourage a certain behavior. For example, the use of a surcharge for health insurance to influence the behavior or those who continue to use tobacco products.

In view of the foregoing, it can be seen that there is a need for a web based system that provide for economic interventions to create incentives for consumer behavior changes to engage in specific preventive care or health promotion practices.

A Instant
Provides instant measurable cash rewards

Simple
Rewards are fulfilled through a regular POS transaction or DDA accounts

Automatic
Once signed up to participate, rewards are processed at time of purchase or transaction

Discrete
Customer does not have to present discount card or coupons.

### OBJECTS OF THE INVENTION

One object of the invention is to provide an electronic capture system capable of identifying, recording and reporting patient behavior.

Another object of the invention is to provide an electronic platform to offer economic incentives or disincentives for patient behavior.

Yet another object of the invention is a system that provides an electronic platform for Communication, Educational and Behavior modification activities or methods

Still another object of the invention is a system that interphases with insurance companies and health providers computer systems.

Yet another object of the invention is a system that records individual health behavior data for companies and health providers to provide information for more effective intervention strategies.

Still another object of the invention is to provide for an economic incentive and disincentive system for patients that operates discreetly so that no inconvenience is added at checkout.

Another object of the invention is to provide a data clearinghouse which interacts with patients, health insurance providers and insurance companies.

Yet another object of the invention is to provide a Provider/Cellular Program and Switch System which facilitates sales using cellular telephone technology.

These and other objects of the present invention will be readily apparent upon review of the following detailed description of the invention and the accompanying drawings. These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

### SUMMARY OF THE INVENTION

A web based electronic capture system that provide for economic interventions to create incentives for consumer behavior changes to engage in specific preventive care or health promotion practices while offering the most efficient and effective system to deliver the best terms and conditions for the products and services requested by customers. The system includes an electronic funds transfer card that can be used as a debit or charge card to purchase goods and services or a magnetic stripe ID card. At checkout, the system operates invisibly to the patient and the provider. Approval of the transaction operates similarly to the conventional debit card or credit card and/or the conventional health insurance ID card. All incentives or disincentives are managed by the data clearinghouse which receives patient and providers data. The clearinghouse communicates with the insurance company and forwards a statement which displays the accumulated incentives or disincentives to the patient. In an alternative embodiment, cellular communications are employed to transmit transaction information between insurance company and the patient and provider.

The system would preferably include participation by multiple insurance companies and a wide variety of providers. Patients join the reward system by subscribing to an insurance plan of a participating company.

### BRIEF DESCRIPTION OF THE DRAWINGS

FIG. 1 is a diagram showing the membership account opening process;

FIG. 2 is a diagram showing the purchasing transaction process

FIG. 3 is a diagram showing the cellular transaction process.

### DETAILED DESCRIPTION OF THE PREFERRED EMBODIMENT

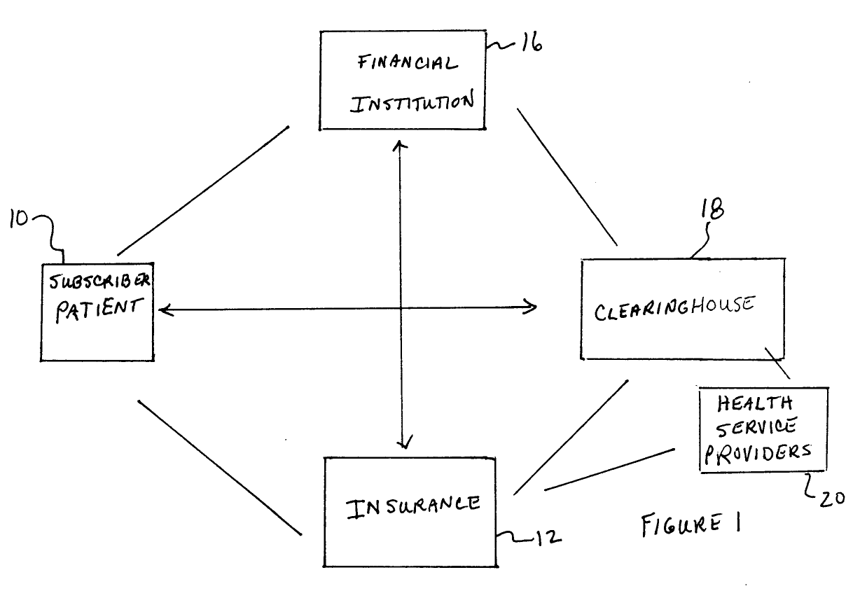

With reference to FIG. 1, the process by which a subscriber/patient can open an account to become a participant with the insurance program is shown. The subscriber 10 initiates the process by sending an application form to open an account with a participating insurance provider 12. It should be understood that the insurance provider may be a governmental institution or a private insurer. The insurance provider 12 creates a health services account for the subscriber 10. The subscriber 10 is then issued an account card with indicia in the form of numbers, bar codes, magnetic strip or other electronic or machine readable media from the insurance provider 12 or the insurance provider 12 may use a traditional credit card account through a financial institution 16 and a clearinghouse 18. The clearinghouse 18 operates to sort information between health service providers 20, the financial institution 16 and the insurance provider 12

Health service providers 20 who are subscribers with insurance providers also register with the transaction clearinghouse 18 to participate in the program.

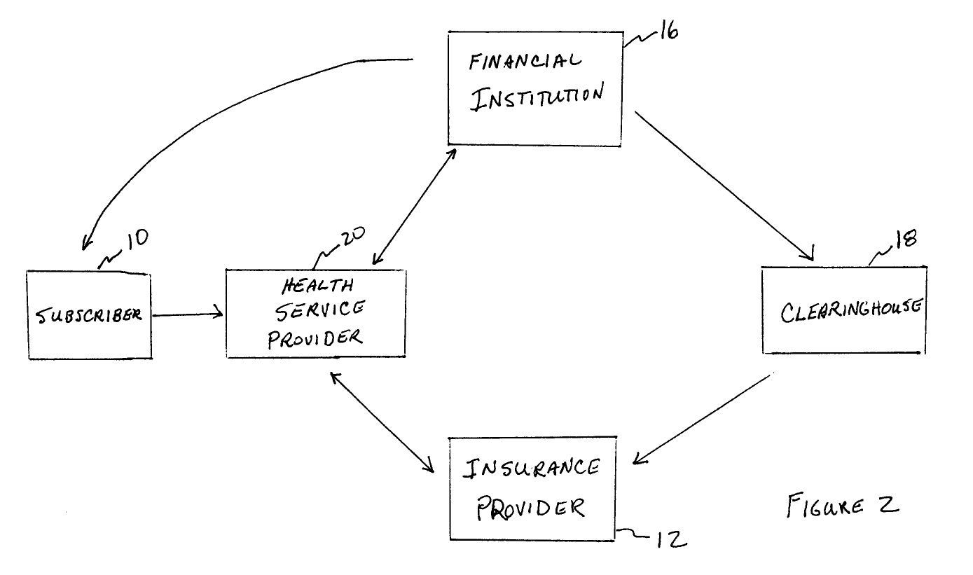

Now the process by which an actual transaction occurs will be described with reference to FIG. 2. The first step is that a subscriber/patient 10 receives a service from a health service provider 20 and pays for the service using the debit or charge card issued from a participating insurance provider 12 or an affiliated financial institution 16. As in a typical credit card transaction, the card is scanned at the office credit card scanner or keyed in as necessary. The service is recorded as in a conventional credit card transaction and the subscriber 10 receives a receipt for the transaction.

At the health service provider level, the transaction is received by the insurance provider or the financial institution 16 in the traditional process. The financial institution 16 then transmits the service information to the transaction clearinghouse 18 which records the information. The information will include the customer information, the service information which can be presented in the form of codes or other service identifiers so that the precise service purchased can be readily identified. The transaction clearinghouse 18 contacts the insurance provider 12 for the discount amount for each service and then sends a debit instruction to the financial institution 16 to obtain the credit for the subscriber/patient 10 equaling the discount. On the next monthly statement, the debit/credit card of the subscriber 10 is credited with the discount for each discount obtained. Alternatively, this information could be instantaneously obtained by the subscriber through an online internet service.

One purpose of the invention is to modify the behavior of the population in general, and to the high risk individuals and patients in specific, as it relates to their potential or existing diseases, by engaging them in specific preventive care or health promotion activities.

From the public health point of view is simple to argue that prevention practices will result in an increase in society well being by extending productive life. Therefore even when activities like screening could at first glance appear more expensive than treatment early detection is cost efficient.

For example the cost of screening will be a function of the unit price of the test/analysis/treatment or assessment (vaccination, physical exam, mammography, PSA, blood pressure test, diabetes test, colonoscopy, imaging, etc), times the number of test needed to diagnose a positive case. For instance; if it takes 750 mammographies to detect a tumor and the cost per test is $1000 the society cost is $750,000.

The benefits on the other hand are more complex; it includes the increase in average life expectancy of the diagnosed party times his or her average projected income (assuming that income accurately reflects the person worth to the society) plus the differential (reduction) in the cost of treatment due to treatment at an early stage. Another additional, albeit difficult to calculate benefit, relates to the opportunity cost of family care.

Needless to say, is difficult if not impossible to predict the onset or recurrence of a disease, much less the occurrence of another not related illness that will affect the post diagnosed life expectancy. Accurate measurements will also require adjustment for the present value of money, because in general most of the medical expenses on a person tend to cluster toward the end of his or her life, the more that moment is postponed the more savings will be accrued.

Obviously the incidence of the disease and the cost of treatment will bear into the social priorities. Even if prevention and health promoting activities are desirable funds will need to be allocated among them.

From the point of an insurance carrier the cost portion is the same. But the benefit portion is different since it involves the additional premiums to be paid during the extended life expectancy as opposed to the average income. The adjustment for the present value of money will also be different since the cost of capital is not the same for the society as a whole than for an insurance company.

A more specific transaction will now be described with respect to the following example. A subscriber 10 obtains a service from a health service provider 20 which could be a mammogram, PSI test or a blood test for example. The insurance provider 12 has previously established an insurance discount for subscribers 10 who obtain such services. The subscriber 10 uses the insurance card issued by the insurer or a bank card issued by the participating financial institution 16 to pay the health service provider. The card is swiped through a optical or magnetic card reader and the information will be processed at either the insurance provider server or if a credit card is used, the financial institution server and will also be detected by the transaction clearinghouse server. If the credit card is used, the transaction clearinghouse 18 will contact the server at the health service provider level and check the detail on the transaction which will include an item by item purchase record. The clearinghouse server will calculate the discounts. The entire breakdown will be reported to the insurance provider server.

The transaction clearinghouse server then invoices the insurance provider 12 and stores the information. When the transaction clearinghouse 18 receives payment from the insurance provider 12, the health service provider's account is credited. The monthly insurance provider statement sent to the subscriber 10 will include a discount based on the health services received.

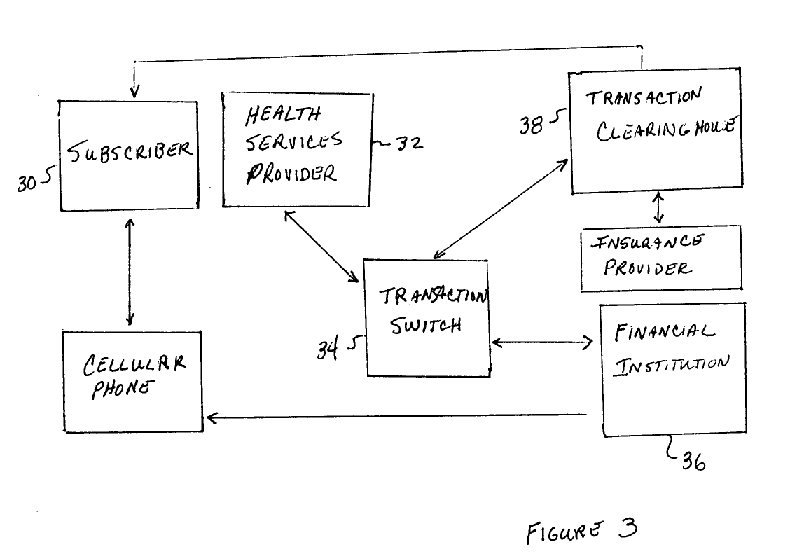

In an alternative embodiment as will be described with reference to FIG. 3, an integrated subscriber/cellular program and switch system allows exchanging transaction information in a way that allows the subscriber 30 to bypass using a bank card. In this embodiment, for example, subscriber 30 initiates a purchase of services at the point of sale, i.e. the health service provider's location. The health service provider 32 sends information such as a health service provider's identification code to a transaction switch 34 which posts service information to the participating financial institution 36 and to the transaction clearinghouse server 38. The health service provider 32 also provides subscriber identifying information such as a name, customer number or telephone number. Upon receipt of the subscriber identification information and the service information by the financial institution 36, the subscriber 30 is then contacted via cell phone by the financial institution 36 and information is provided by the subscriber 30 to the financial institution 36 in the form of a personal identification number (PIN) or other password confirming the customer's intent to purchase.

Alternatively, the subscriber 30 can initiate the transaction via cell phone and the financial institution 36 would contact the health service provider 32 for the service data.

The subscriber reward attributes will operate in the Cellular system in the same manner as in the card transaction system as previously described.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims.

We claim:

1. A method of facilitating a reward program for distribution of health services comprising the steps of:
a) forming a health insurance network including health insurance subscribers and health insurance providers;
b) monitoring transactions between said subscribers and said providers;
c) providing rewards to said subscribers when said subscribers obtain health services from a health service provider based upon the type of health services received.

2. The method of facilitating a reward program as set forth in claim 1, further comprising the step of:
providing subscribers with a statement from said providers.

3. The method of facilitating a reward program as set forth in claim 1, wherein:
when a subscriber obtains services from a health service provider, said subscriber uses a card having a machine readable indicia thereon to purchase said services.

4. The method of facilitating a reward program as set forth in claim 3, wherein:
said service provider scans said card through a scanning device which transmits subscriber information to said insurance provider for purchase authorization.

5. The method of facilitating a reward program as set forth in claim 1, further comprising the step of:
transmitting purchase authorization information from said subscribers to said insurance provider using a cellular telephone.

6. The method of facilitating a reward program as set forth in claim 1, further comprising the step of:
providing health insurance premium discounts based on services received from health service providers.

7. A method of operating a reward program, comprising the steps of;
a) creating a reward program group of at least one participating insurance provider and at least one financial institution and a data clearinghouse;
b) enrolling at least one insurance subscriber and providing said subscriber with an account;
c) initiating a service by said subscriber at a health service provider;
d) transmitting service information from said financial institution to said data clearinghouse which records said service information;
e) said service information includes item identifiers so that obtained services can be identified;
f) calculating the total discount based on said service by said data clearinghouse;
g) wherein, upon receipt of said service, said data clearinghouse applies a credit to said subscriber's account.

8. The method of operating a reward program as set forth in claim 7, further comprising the step of;
using a cellular telephone to provide account information to said financial institution.

9. A system for facilitating a reward program comprising:
a) an insurance network including subscribers, health insurance providers and financial institutions;
b) a data clearinghouse server for recording transaction data between subscribers and health service providers and financial institutions;
c) said transaction data includes service detail information from a health service provider when a subscriber obtains health services from a health service provider;
d) said service detail information includes item by item discounts on services;
e) said data clearinghouse server calculates reward information and authorizes said data clearinghouse to obtain a subscriber refund from said financial institution; and,
f) said subscriber receives a statement identifying said refund information.

10. The system of facilitating a reward program as set forth in claim 9, further comprising:
a cellular phone for transmitting service information from said subscriber to said financial institution.

11. The system facilitating a reward program for buying club members as set forth in claim 10, wherein:
said service information includes an item by item list of received services.

12. The system of facilitating a reward program as set forth in claim 11, wherein:
rewards are determined from said service detail information on an item by item basis.

13. A method of operating a reward program, comprising the steps of;
a) creating a reward program group of at least one health service provider and at least one insurance provider and a data clearinghouse;
b) enrolling at least one customer as a patient and providing said patient with an account;
c) initiating a purchase by a patient at said health service provider using said account;
d) obtaining authorization for said transaction from said insurance provider;
e) transmitting behavior information from said insurance provider to said data clearinghouse which records said behavior information;
f) said behavior information includes item identifiers so that purchased products and services can be identified;
g) transmitting a request for incentives or disincentives amount from said data clearinghouse to said insurance company;
h) calculating a total incentive or disincentive of said purchase by said data clearinghouse;
i) invoicing by said data clearinghouse from said insurance company for the total incentives;
j) sending to said data clearinghouse from said insurance company payment of the invoice amount;
k) wherein, upon receipt of said payment, said data clearinghouse applies a credit to said patient's account.

14. The method of operating a reward program as set forth in claim 13, wherein;
providing a patient with an account includes providing said patient with a debit card.

15. The method of operating a reward program for a member as set forth in claim 13, wherein;
providing a patient with an account includes providing said patient with a credit card.

16. The method of operating a reward program for a patient as set forth in claim 13, wherein;
providing a patient with an account includes providing said patient with a personal identification number.

17. The method of operating a reward program for a patient as set forth in claim 16, further comprising the step of;
using a cellular telephone to provide account information to said insurance company.

18. The method of operating a reward program for a patient as set forth in claim 13, further comprising the step of;
using an card scanning device to transmit account information to said insurance company.
